(19) United States
(12) Patent Application Publication
(10) Pub. No.: US 2014/0317006 A1
(43) Pub. Date: Oct. 23, 2014

(54) MARKET SPECIFIC REPORTING MECHANISMS FOR SOCIAL CONTENT OBJECTS

(71) Applicants: Jacob Andrew Brill, San Francisco, CA (US); Arturo Bejar, Saratoga, CA (US); Emiliana Ricci Simon-Thomas, Berkeley, CA (US); Kayhan Paul Piff, Oakland, CA (US); Dacher Joseph Keltner, Berkeley, CA (US)

(72) Inventors: Jacob Andrew Brill, San Francisco, CA (US); Arturo Bejar, Saratoga, CA (US); Emiliana Ricci Simon-Thomas, Berkeley, CA (US); Kayhan Paul Piff, Oakland, CA (US); Dacher Joseph Keltner, Berkeley, CA (US)

(21) Appl. No.: 13/868,802

(22) Filed: Apr. 23, 2013

(51) Int. Cl. G06Q 50/00; G06Q 10/00

(52) U.S. Cl. CPC G06Q 50/01; G06Q 10/00
USPC 705/319

(57) ABSTRACT

Technology for providing reporting options specific for a market or a common user attribute is disclosed herein. A computer server of a social networking system determines multiple community standards for a group of users of a social networking system, wherein the group of users have a common user attribute such as a common market. The computer server receives a request for reporting a content object in the social networking system from a user among the group of users. The computer server determines multiple reporting options based on the community standards, and transmits the reporting options to the user in response to the request. The reporting options represent potential reasons why the user reports the content object

### BACKGROUND

While the Internet offers access to a wealth of educational, entertainment, and similar materials of interest to a wide variety of people, it is also replete with information perceived as offensive or inappropriate by some people. Many websites, particularly social network websites, include contents that are created by users of the websites. The appropriateness or offensiveness of the user provided content may become a difficult problem to address.

Requiring that all content submitted by users be reviewed by the hosting organization places a limit on the amount of content that can make it to the site, since it depends upon the website organization's internal resources available to review that material. This may be further complicated when multiple languages are taken into consideration. Furthermore, a malicious user could post hundreds or thousands of instances of objectionable content all requiring individual review or filtering.

On the other hand, setting the bar too high may unnecessarily limit user provided content to a website. Typically in social networking systems, a majority of content comes from a portion of contributors who are active participants on the social networking systems. If the bar has been set too high, the active participants can be discouraged from producing contents.

One approach to curtailing objectionable behavior in a social networking system is to manually collect feedback from disgruntled users of the social networking system. A user may report abusive behavior to a human operator of the social networking system after receiving unwelcome activity from other users of the social networking system. Unfortunately, this approach relies on user feedback, which may be slow and sporadic. Some users may stop using the social networking system rather than being annoyed with unwelcome contents or having to submit complaints to a human operator.

### SUMMARY

Technology for providing reporting options specific for a market or a common user attribute is disclosed herein. The reporting options for reporting a potentially inappropriate content object are customized based on one or more common attribute of a group of users, such as the geographical market of the users, and/or the language of the users. For instance, the customized reporting options can change on a per market basis. By choosing one of the customized reporting options, a user can pinpoint accurately the reason why the user wants to report the potentially inappropriate content object of the social networking system.

According to at least one embodiment, a computer server of a social networking system determines multiple community standards for a group of users of a social networking system, wherein the group of users have a common user attribute such as a common market. The computer server receives a request for reporting a content object in the social networking system from a user among the group of users. The computer server determines multiple reporting options based on the community standards, and transmits the reporting options to the user in response to the request. The reporting options represent potential reasons why the user reports the content object.

Other aspects of the technology introduced here will be apparent from the accompanying figures and from the detailed description, which follows.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates an example environment in which a social networking system may exist and in which objectionable conduct may occur.

FIG. 2 illustrates an example architecture of a server that may be used in a social networking system.

FIG. 3 is a block diagram illustrating an example of a social content reporting system.

FIG. 4 is a high-level flowchart illustrating an example process for providing reporting options specific for a market or a common user attribute.

FIG. 5 is a high-level block diagram showing an example of the architecture of a computer server, which may represent any of the servers of the social networking system.

### DETAILED DESCRIPTION

References in this description to “an embodiment”, “one embodiment”, or the like, mean that the particular feature, function, or characteristic being described is included in at least one embodiment of the present invention. Occurrences of such phrases in this description do not necessarily all refer to the same embodiment, nor are they necessarily mutually exclusive.

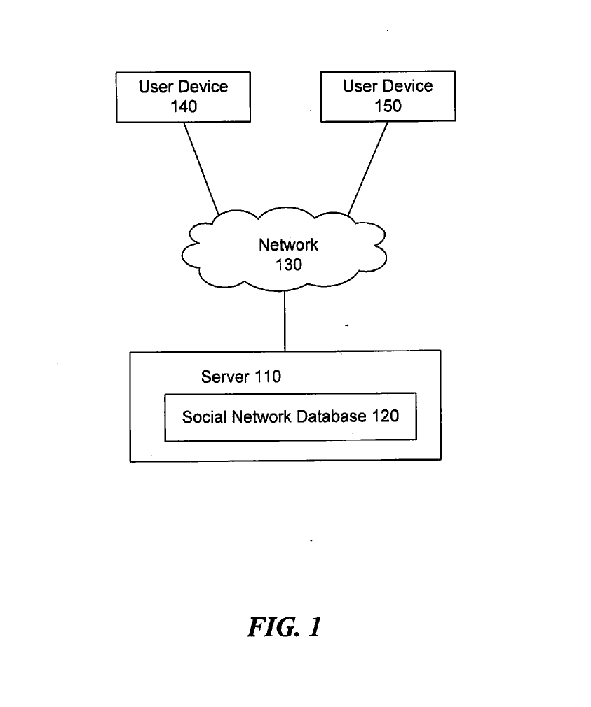

FIG. 1 illustrates an example environment 100 in which a social networking system may exist and in which objectionable conduct may occur. Environment 100 comprises a server 110, a network 130, and user devices 140 and 150. A social network database 120 is located on the server 110.

The server 110 monitors user activity and determines whether a predetermined policy is violated. The database 120 manages user information that is accessed by users of the social networking system. The server 110 and the database 120 are discussed further herein.

The network 130 provides the medium for communication between the server 110 and user devices 140 and 150. The network 130 may be the Internet, a wireless or wired network such as a mobile device carrier network, or any other network that can be used for communication between a server and a client.

In one embodiment, the user device 140 is used by a user initiating the actions being monitored by the server 110. The user device 150 is used by a recipient of the monitored actions. User devices 140 and 150 may each be a computer or a mobile device, such as a mobile phone, a cell-phone, a smart-phone, a personal digital assistant, a notebook computer, a laptop computer or a hand-held game console.

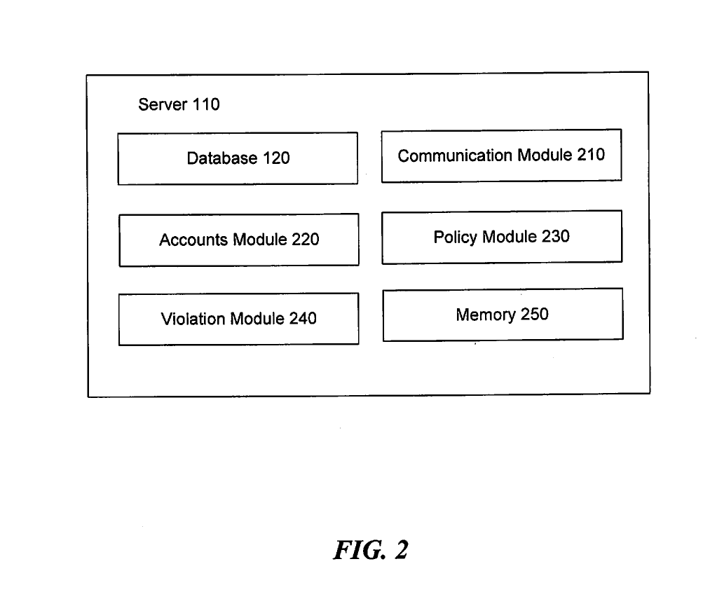

FIG. 2 illustrates an example architecture of a server 110 that may be used in a social networking system. The server 110 comprises the database 120, a communication module 210, an accounts module 220, a policy module 230, a violation module 240, and memory 250.

The communication module 210 may be used to communicate with user devices 140 and 150. The accounts module 220 monitors and/or receives actions from user devices, such as user device 140. Actions from user device 140 that affect or create certain content objects, are time-stamped and the type of content objects is recorded in memory 250.

The policy module 230 stores one or more policies which determine whether a content object is objectionable or inappropriate. A policy may be represented by a function regarding a type of content object. Such functions may be linear, exponential, polynomial, or step functions, functions of acceleration, i.e., a function of time squared, or any other function that can be used to measure certain attribute of content objects. In some embodiments, a representative curve of the policy threshold has an initial steep slope that gradually decreases over time.

The policy may have different thresholds of violation for different degrees of the same type of content object, e.g., a warning threshold which results in some warning to the offending user, and a suspension threshold which removes rights from the user. A suspension may be temporary, for example for hours, days, or months, or may require a system operator to reactivate a user's account prior to further actions. A suspension may help curtail spammers from abusing the social networking system. In various embodiments, the time of a temporary suspension is extended if a user attempts to repeat the type of action that resulted in suspension of the account.

The violation module 240 determines whether a user or a content object has violated the policy. The violation module 240 compares the number and type of actions and content objects recorded by the accounts module 220 with the policy stored in the policy module 230. Upon reaching a threshold, the violation module 240 performs operations on the content object, e.g. removing the content object or restricting access to the content object. The violation module 240 may further respond by requesting the communication module 210 to issue a warning to the user and/or by altering a user record in the database 120 to suspend the user's account.

The server 110 may include memory 250 to store applications or modules and other information. In some embodiments, applications, modules, and/or database 120 may reside in memory on several servers (not shown). The server 110 can further include a social content reporting system via which a user can report certain inappropriate content in a social networking system.

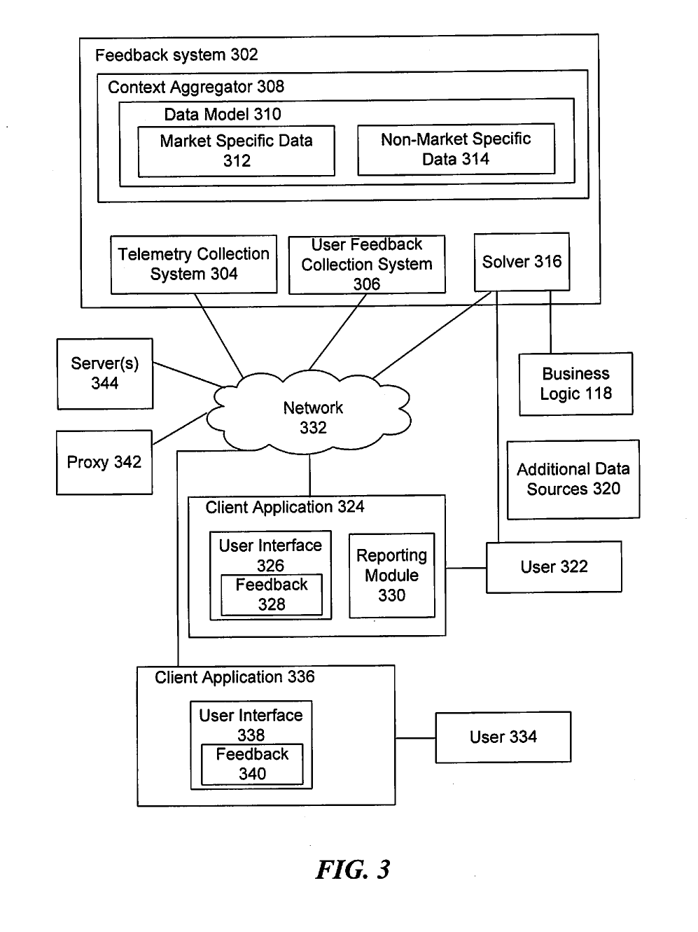

FIG. 3 is a block diagram illustrating an example of a social content reporting system 302, (also referred to as reporting system or feedback system). The reporting system 302 includes a telemetry collection system 304 and a user feedback collection system 306. A context aggregator 308 collects data from both the telemetry collection system 304 and the user feedback collection system 306, and constructs a data model 310 that characterizes the data. Using this data model 310, as explained in more detail below, the feedback system 302 is able to respond to the reports or feedbacks in a timely, convenient, and useful way.

The telemetry collection system 304 is responsible for receiving a stream of data that provides information about an environment of a user, such as, for example, an application being used by the user, a physical location of the user, a user profile of the user. The telemetry data may provide continuous information about an environment of a user, as the user proceeds report an inappropriate content. The telemetry data may provide information about when, where, or why the user is experiencing the inappropriate content in the social networking system.

The user feedback collection system 306, in contrast, is designed to obtain structured or unstructured feedback information that is entered actively and/or directly by a user. For example, the user feedback collection system 306 may be used to present one or more questions to the user about a content object being experienced by the user. The user may respond by selecting from a list of possible answers, and/or by inputting unstructured feedback (e.g., a written description of a problem). The user feedback collection system 306 may thus provide specific information about a particular problem, or may narrow the problem to within a defined range or selection of possible problems or class(es) of problems.

The context aggregator 308 may then combine the telemetry data collected by the telemetry collection system 304 with the user input collected by the user feedback collection system 306 to construct the data model 310 describing a context of the user. In other words, the data model 310 describes the particular circumstances or setting of a user of the social networking system, as the user uses the social networking system. The context of a user might refer to the user's technical context (e.g., type of application(s) and/or system(s) being used), as well as the user's social context (e.g., the user's geographical location). As such, and as discussed in more detail below, the data model 310 provides a basis by which an inappropriate content object may be identified and/or resolved. A content object can be an image, a video, an audio, a topic, a message, a description, a comment, a rating, or other object in a social networking system.

In FIG. 3, the context aggregator 308 constructs the data model 310 having a market specific data portion 312 and a non-market specific portion 314. The market specific portion 312 contains information pertaining to a particular market which the user belongs. In contrast, the non-market specific portion 314 contains information that is not particular to a given market.

In various embodiments, the context aggregator 308 can compile the data model using a pre-determined, standardized format. That is, pieces or types of information included in the data model 310 are associated with a pre-determined format, with predetermined units, and/or with respect to a pre-determined point of reference. For example, location information may be stored using latitude and/or longitude coordinates, while time may be measured in milliseconds. Similarly, a language being used by a user and application may be designated in a predetermined manner (e.g., languages English, German, or French may be abbreviated according to a standard abbreviation format). As another example, a name or abbreviation for a particular market may be pre-selected.

In various embodiments, the context aggregator 308 can construct multiple data models for any or every user of the feedback system 302. Since, as just described, these data models each contain words and designations that have the same meanings, regardless of the source from which the particular values were obtained, the different data models may be meaningfully compared and analyzed, across a wide range of users and markets (or other user attributes).

A solver 316 is included in the feedback system 302 that analyzes the data model(s) 310 and determines an appropriate response. For example, the solver 316 may determine a solution to an inappropriate content object being experienced by a user.

In determining a solution, the solver 316 has various resources at its disposal. For example, the solver 316 has access to many or all of the data models 310 produced by the context aggregator 308, and may analyze these data models 310 to arrive at a conclusion. For example, the solver 316 may examine multiple data models 310 and determine that users who are in a particular location and are experiencing a similar content object. Based on this information, the solver 316 may determine that the content object is offensive to users at that location because of a cultural reason. The standardization of data models 310 across multiple users and markets facilitates this determination on the part of the solver 316.

Additionally, the solver 316 may have access to other components or resources to assist in the process of addressing the content object and improving user experience. For example, the solver 316 may access business logic 318, which represents, for example, a conventional, rule-based set of definitions for a business process. The business logic 318, for example, may define a timing or sequence of business events or transactions, or may define business pre-requisites for accessing certain content objects. As one example, the business logic 318 may require that only users who confirm he or she is over 18 years old can access a particular content object.

The solver 316 also may have access to additional data sources 320, generically represented in FIG. 3 and referring to, for example, a geographic location of a user or server, network status conditions, or any other information that may be useful to the solver 316 in identifying or resolving the issues regarding the identified content objects.

In operation of the end user experience feedback system 302, then, a user 322 uses a client application 324 that includes a user interface 326. The user interface 326, in turn, includes a feedback button 328. The feedback button 328 may be included across a large number of interfaces, e.g., web pages, associated with a particular software application. Upon experiencing a content object that can be potentially inappropriate or otherwise wishing to express feedback, the user 322 clicks the feedback button 328.

At this point, a reporting module 330 integrated with the client application 324 may begin transmitting telemetry data to the telemetry collection system 304. For example, if the user interface 326 is a web page, the reporting module 330 may include a Java script for, for example, measuring and reporting a response time of the web page. At approximately the same time, the user feedback collection system 306 presents a question or series of questions to the user 322, perhaps using the user interface 326 (or a separate interface, not shown in FIG. 3).

Both channels of information may thus be provided to the feedback system 302, for example, over a network 332. The network 332 may be, for example, a local area network (LAN), or a wide area network (WAN), such as the public Internet. The network 332 may be freely available, or may be limited to an enterprise or other network provider. Of course, it is also possible that the software application may be directly connected to the feedback system 302, without use of the network 332. Further, in some implementations, some or all of the functionality of the feedback system 302 may be integrated within the client application 324.

In some other embodiments, little of the functionality for using the feedback system 302 need be integrated with the client application (e.g., the reporting module 330 may be omitted). For example, another user 334 of an application 336 having a user interface 338 may have only a feedback button 340 integrated with the application 336 for using the feedback system 302. Upon selecting the feedback button 340, a proxy 342 intercepts or eavesdrops on communications from the application 336, and transmits this data to the telemetry collection system 304 as the telemetry data. For example, the proxy 342 may intercept communications between the client application 336 and a server(s) 344, such as a request for a particular web page associated with the application 336.

The feedback system 302 can collect data from multiple users 322, 334, who may be using the same or different client applications 324,336. The data may include data from the additional data sources 320, which may provide data that are relevant to the context of a user but that may not be stored in the client applications 324,336. The additional data sources 320 may (or may not) be local to, for example, the user 322.

The feedback system 302 compiles standardized data models 310 that include information about the users 322,334 and client applications 324,336, and uses the data models 310 to analyze information about the users 322,334 and application(s) 324, 336. In this way, the feedback system can, for example, consider a proposed improvement, or present a solution regarding the potentially inappropriate content object.

In some settings, then, a user may obtain a solution regarding potentially inappropriate content object immediately, such as when the solver 316 is able to present a solution, perhaps selected by the solver from one of a number of known solutions for an identified content object, directly to the user. In these cases, the user receives a solution in a minimum amount of time, without having to interact with support staff.

When the solver 316 is unable to present satisfactory information or resolution to, for example, the user 322, the solver 316 may act to create an adaptive virtual community for assisting the user 322. That is, the solver 316 may identify a support staff who has particular expertise or knowledge of the content object presented by the user 322, and may facilitate communication between the support staff and the user 322, whereby the user 322 may be made aware of a solution in a timely and convenient manner.

Although one example of a user feedback system is described above with respect to FIG. 3, many other implementations also may be used in various embodiments. For example, although the feedback buttons 328, 340 are shown above for instigating transmission of telemetry data, the telemetry data may be instigated by some other cause, such as a user providing a negative comment for a particular social content object. Further, although the telemetry data is described above as a stream of data that is transmitted continuously, the term telemetry data also may include intermittent or interrupted transmissions of data.

The feedback system 302 can provide benefits to virtually all parties associated with the use or provision of client applications. For example, the users 322 and 334 may experience solution regarding the potentially inappropriate content object that is provided quickly and conveniently.

Administrators or operators of the social networking system may be given access to data models 310 constructed by a plurality of context aggregators 308, perhaps across multiple providers (e.g., may have access to feedback systems 302 used by multiple social networking systems deploying the technology). In this way, the social networking system may be able to efficiently manage allocation of resources for responding to customer problems, including adjusting a number of support staff for manually addressing the issues of inappropriate content objects.

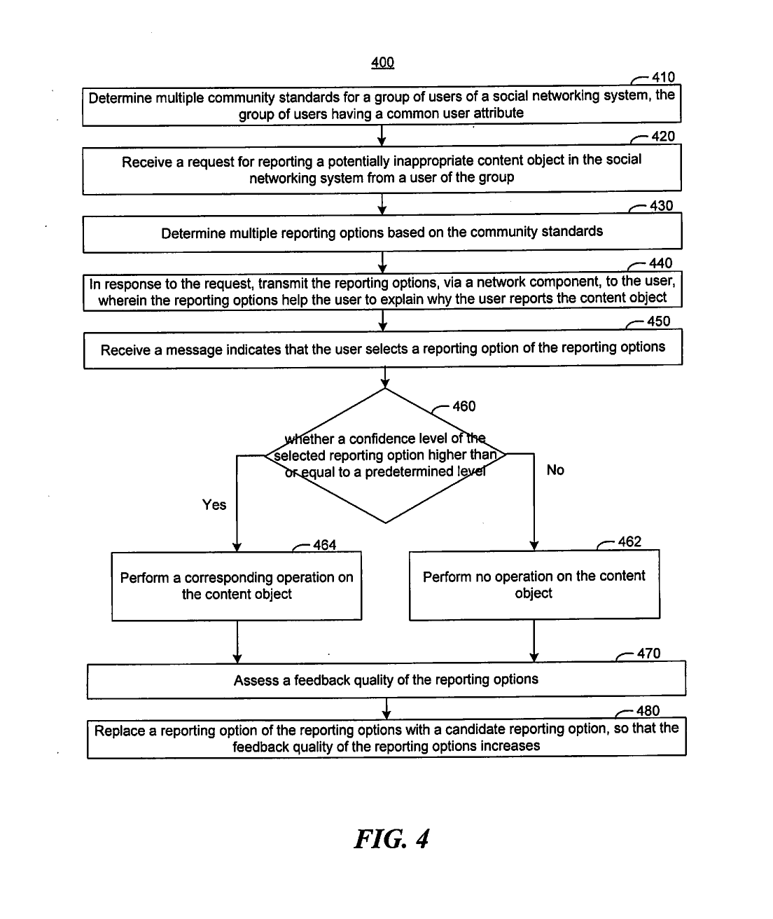

FIG. 4 is a high-level flowchart illustrating an example process 400 for providing reporting options specific for a market or a common user attribute. At step 410 of the process 400, a computer server of a social networking system determines multiple community standards for a group of users of a social networking system, the group of users having a common user attribute. The common user attribute can include, for example, a common geographical market, a common language, a common age range, a common interest, a common religious affiliation, a common industry, a common education level, a common ethnic status, a common characteristic in user profiles of the group of users or other types of user attribute, as readily appreciated by a person having ordinary skill in the art.

At step 420, the computer server receives a request for reporting a potentially inappropriate content object in the social networking system from a user of the group. The content object can include, for example, an image, a video, an audio, a topic, a message, a description, a comment, a rating, or other types of social networking object.

At step 430, the computer server determines multiple reporting options based on the community standards. The reporting options can represent potential reasons why the use reports the content object. For instance, the reporting options can represent reasons including spam, scam, nudity, pornography, graphic violence, hate speech or symbol, illegal drug use, compromised account, no permission of publication, insult, discrimination, terrorism, religious offence or other types of reason as readily appreciated by a person having ordinary skill in the art.

In some embodiments, the reporting options are determined by analyzing one or more related content objects that are related to the content object. For instance, for potentially inappropriate image posted in the social networking system, the computer server may analyze the comments and description regarding the image to determine the reporting options. In some other embodiments, the reporting options are selected from a plurality of candidate reporting options by presenting the candidate reporting options to multiple test users who have the common user attribute and analyzing the responses of the test users.

At step 440, in response to the request, the computer server transmits the reporting options, via a network component, to the user, wherein the reporting options help the user to explain why the user reports the content object.

At step 450, the computer server receives a message indicates that the user selects a reporting option of the reporting options. Optionally in some embodiments, in response to the message, the computer server transmits a user interface procedure to the user, wherein the user interface procedure is configured to retrieve information regarding the content object and the user from the user. The user interface procedure can include multiple layers of inquiry interfaces so that the user can pinpoint the reason that the user report the content object

In some embodiments, in response to the message, the computer server can execute an operation on the content object. The operation can include, for example, deleting the content object from the social networking system, restricting the access of the content object, modifying the content object, automatically closing the request, notifying a human operator of the social networking system, or other types of operations related to the content object.

In some other embodiment, the computer server can choose to perform no operation on the content object depending on the selected reporting option. For instance, at step 460, the computer server can determine whether a confidence level of the selected reporting option higher than or equal to a predetermined level. The confidence level can be generated based on historical data. If the confidence level is lower than a predetermined level, at step 462, the computer server performs no operation on the content object. If the confidence level is higher than or equal to the predetermined level, at step 464, the computer server performs a corresponding operation on the content object.

The computer server can further makes changes to the reporting options so that the reporting options better represent the reasons why users of the common attribute report content objects that they think as inappropriate. At step 470, the computer server assesses a feedback quality of the reporting options. At step 480, the computer server replaces a reporting option of the reporting options with a candidate reporting option, so that the feedback quality of the reporting options increases. The accessing and the replacing can be performed periodically according to a predetermined schedule.

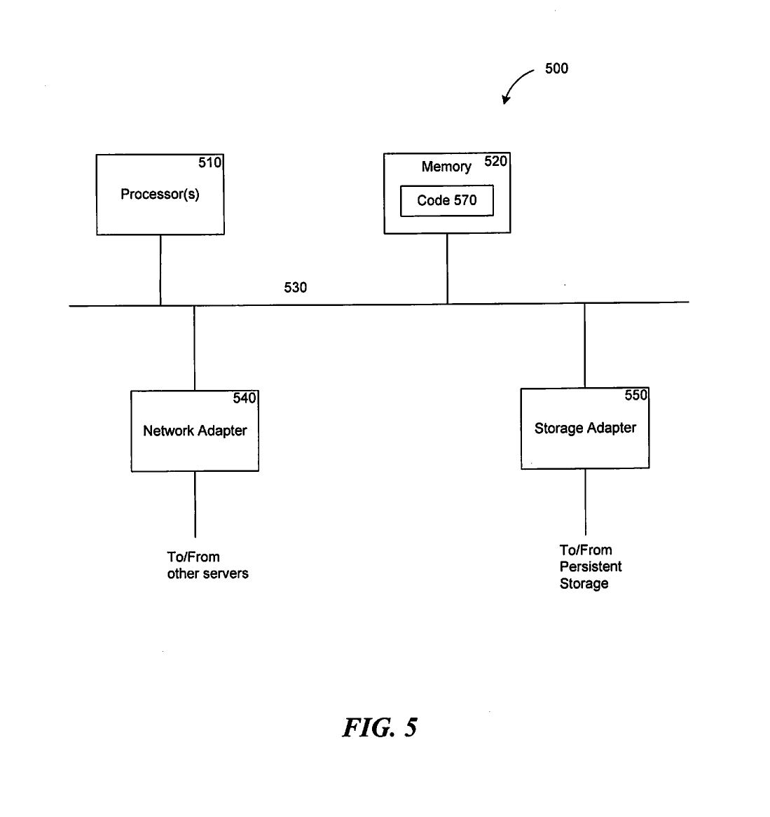

FIG. 5 is a high-level block diagram showing an example of the architecture of a computer server 500, which may represent any of the servers of the social networking system. The server 500 includes one or more processors 510 and memory 520 coupled to an interconnect 530. The interconnect 530 shown in FIG. 5 is an abstraction that represents any one or more separate physical buses, point to point connections, or both connected by appropriate bridges, adapters, or controllers. The interconnect 530, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 510 is/are the central processing unit (CPU) of the server 500 and, thus, control the overall operation of the server 500. In certain embodiments, the processor(s) 510 accomplish this by executing software or firmware stored in memory 520. The processor(s) 510 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 520 is or includes the main memory of the server 500. The memory 520 represents any form of random access memory (RAM), read-only memory (ROM), flash memory, or the like, or a combination of such devices. In use, the memory 520 may contain, among other things, code 570 embodying at least a portion of an operating system of the server 500. Code 570 may also include instructions for executing the techniques disclosed herein.

Also connected to the processor(s) 510 through the interconnect 530 are a network adapter 540 and a storage adapter 550. The network adapter 540 provides the server 500 with the ability to communicate with devices, such as other user devices, front end servers, consolidating servers, data warehouse servers, or back end servers, over a network and may be, for example, an Ethernet adapter or Fibre Channel adapter. In some embodiments, a server may use more than one network adapter to deal with the communications within and outside of the data storage cluster separately. The storage adapter 550 allows the server 500 to access a persistent storage, and may be, for example, a Fibre Channel adapter or SCSI adapter.

The code 570 stored in memory 520 may be implemented as software and/or firmware to program the processor(s) 510 to carry out actions described below. In certain embodiments, such software or firmware may be initially provided to the server 500 by downloading it from a system through the server 500 (e.g., via network adapter 540).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic”, as used herein, can include, for example, programmable circuitry programmed with specific software and/or firmware, special-purpose hardwired circuitry, or a combination thereof.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

What is claimed is:

1. A computer-implemented method comprising:
determining multiple community standards for a group of users of a social networking system, the group of users having a common user attribute;
receiving, at a server of the social networking system, a request for reporting a content object in the social networking system from a user of the group; and
transmitting multiple reporting options, via a network component, based on the community standards to the user in response to the request, wherein the reporting options help the user to explain why the user reports the content object.

2. The computer-implemented method of claim 1, further comprising:
in response to a message indicating that the user selects a reporting option of the reporting options, transmitting a user interface procedure to the user, wherein the user interface procedure is configured to retrieve information regarding the content object and the user from the user.

3. The computer-implemented method of claim 2, wherein the user interface procedure includes multiple layers of inquiry interfaces so that the user can pinpoint the reason that the user reports the content object.

4. The computer-implemented method of claim 1, further comprising:
in response to a message indicating that the user selects a reporting option of the reporting options, executing an operation on the content object.

5. The computer-implemented method of claim 5, wherein the operation includes deleting the content object from the social networking system, restricting the access of the content object, modifying the content object, automatically closing the request, or notifying a human operator of the social networking system.

6. The computer-implemented method of claim 1, further comprising:
assessing a feedback quality of the reporting options; and
replacing a reporting option of the reporting options with a candidate reporting candidate, so that the feedback quality of the reporting options increases.

7. The computer-implemented method of claim 1, wherein the accessing and the replacing are performed periodically according to a predetermined schedule;

8. The computer-implemented method of claim 1, wherein the common user attribute comprises a common geographical market, a common language, a common age range, a common interest, a common religious affiliation, a common industry, a common education level, a common ethnic status, or a common characteristic in user profiles of the group of users.

9. The computer-implemented method of claim 1, wherein the request is a request for reporting a potentially inappropriate content object.

10. The computer-implemented method of claim 1, wherein the content object comprises an image, a video, an audio, a topic, a message, a description, a comment, a rating, or a social networking object.

11. The computer-implemented method of claim 1, wherein the reporting options represent potential reasons why the use reports the content object.

12. A computer-implemented method comprising:
receiving, at a server of a social networking system, a request for reporting a content object in the social networking system from a user device operated by a user of the social networking system;
determining multiple reporting options based on an attribute of a user profile of the user, wherein each of the reporting options represents a potential reason why the user reports the content object; and
transmitting, via a network component, the multiple reporting options to the user device.

13. The computer-implemented method of claim 12, further comprising:
receiving a message, from the user device, indicating that the user selects a reporting option of the reporting options; and
based on the reporting option that the user selects, either
performing no operation on the content object,
or
performing an operation on the content object.

14. The computer-implemented method of claim 12, further comprising:
receiving a message, from the user device, indicating that the user selects a reporting option of the reporting options;
determining a confidence level of the reporting option that the user selects; and
based on the confidence level of the reporting option that the user selects, either
performing no operation on the content object if the confidence level is lower than a predetermined level,
or
performing an operation on the content object if the confidence level is higher than or equal to the predetermined level.

15. The computer-implemented method of claim 13, wherein the reporting options represent reasons including spam, scam, nudity, pornography, graphic violence, hate speech or symbol, illegal drug use, compromised account, no permission of publication, insult, discrimination, terrorism, or religious offence.

16. The computer-implemented method of claim 13, wherein the reporting options are determined by analyzing one or more related content objects that are related to the content object.

17. The computer-implemented method of claim 13, further comprising:
presenting at least a portion of candidate reporting options to a group of test users; and
determining satisfaction levels of the group of test users in response to the presented candidate reporting options, the group of test users having the attribute; and
wherein the reporting options are determined from the candidate reporting options based on the satisfaction levels of the group of test users.

18. A computer server of a social networking system, the computer server comprising:
a networking component configured to communicate with a user device operated by a user of the social networking system;
a processor; and
a memory storing instructions which, when executed by the processor, cause the computer server to perform a process including:
determining multiple community standards for a group of users of the social networking system, the group of users having a common user attribute;
receiving a request for reporting a content object in the social networking system from the user device; and
transmitting multiple reporting options, via the networking component, based on the community standards to the user device in response to the request, wherein the reporting options represent potential reasons why the user reports the content object.

19. The computer server of claim 18, wherein the reporting options are generated by extracting topics or tags from one or more related content objects that are related to the content object.

20. The computer server of claim 18, wherein the reporting options are selected from a plurality of candidate reporting options by presenting the candidate reporting options to multiple test users who have the common user attribute and analyzing the responses of the test users.
